(19) United States
(12) Patent Application Publication
(10) Pub. No.: US 2019/0279152 A1
(43) Pub. Date: Sep. 12, 2019

(54) INTELLIGENT STAMP FOR DELIVERY TRACKING AND RECORDING

(71) Applicant: Xerox Corporation, Norwalk, CT (US)

(72) Inventors: Peter Granby, Hertfordshire (GB); Christopher Dermott Wigens, Hertfordshire (GB); Rajana Mukesh Panchani, London (GB)

(73) Assignee: Xerox Corporation

(21) Appl. No.: 15/918,031

(22) Filed: Mar. 12, 2018

(51) Int. Cl. G06Q 10/08; G06F 3/06

(52) U.S. Cl. CPC G06Q 10/0833; G06F 3/062; G06K 19/06037; G06F 3/0679; G06F 3/0655

(57) ABSTRACT

Methods, systems, and devices for tracking and recording package delivery data. In an example embodiment, a memory label can be provided, which includes micro-circuits printed on the memory label. Such micro-circuits include rewritable memory. The memory label is configured to include a pre-determined set of data regarding a package to be delivered in a delivery workflow. The pre-determined set of data is stored in the rewritable memory. The pre-determined set of data can be updated at each subsequent point in the delivery workflow to produce updated data about the package.

### TECHNICAL FIELD

Embodiments are generally related to the field of distribution networks, such as delivery networks. Embodiments also relate to methods and systems for providing real-time information about items in a distribution network. Embodiments are additionally related to the field of printed memory circuits configurable on flexible substrates.

### BACKGROUND

Items can be received, tracked, and distributed using distribution networks. As items are travelling through the distribution network, such as a delivery network, the status of each item at any time may not be available. Thus, operators of distribution networks, such as, e.g., the United States Postal Service, or others, may desire to provide real-time tracking and full item visibility as items move throughout the distribution network. By being able to track item status in real-time, a distribution network can realize an improvement in operation, efficiency, and distribution analytics, and provide improved new products and services for users of the distribution network.

Presently, however, in such distribution networks including delivery networks or delivery environments, there does not exist a means for reliably and efficiently capturing instant data regarding, for example, where the item (e.g., a package, parcel, letter, etc.) is located in the delivery system, and where the item has come from and where it is going.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the, entire specification, claims, drawings, and abstract as a whole.

It is, therefore, one aspect of the disclosed embodiments to provide for improved distribution networks (e.g., delivery networks or delivery environments).

It is another aspect of the disclosed embodiments to provide for improved methods, systems, and devices for provided real-time information about items in a distribution network.

It is a further aspect of the disclosed embodiments to provide for printed memory circuits configured on flexible substrates such as labels and tickets utilized for labeling and tracking items through a delivery work flow in a distribution network.

The aforementioned aspects and other objectives and advantages can now be achieved as described herein. Methods, systems, and devices are disclosed for tracking and recording package delivery data. In an example embodiment, a memory label can be provided, which includes micro-circuits printed on the memory label. Such micro-circuits include rewritable memory. The memory label is configured to include a pre-determined set of data regarding a package to be delivered in a delivery workflow. The pre-determined set of data is stored in the rewritable memory. The pre-determined set of data can be updated at each subsequent point in the delivery workflow to produce updated data about the package.

The memory label can be configured as a reusable label that is reusable for future packages. The memory label generally includes printed information about the package. In addition, the memory label can be attached to the package at an initial point in the delivery workflow. The memory label includes both the printed information and the pre-determined set of data (and/or other data such as the aforementioned updated data). The package can be monitored at each point in the delivery workflow utilizing the updated data about the package. In addition, data contained in the printed memory can be communicated to a front end device with a read/write base unit, wherein the data comprises the pre-determined set of data and/or the updated data. The data can be communicated to the front end device from the read/write base unit through a secure communications link comprising wireless data communications or a wired data communications link. In addition, the data can be written to the printed memory from a read/write base unit, wherein the data comprises the pre-determined set of data and/or the updated data.

Additionally, a write request can be transmitted from the front end device to the read/write base unit in response to a request to update data printed memory. The updated data can be written to the printed memory from the read/write base unit in response to the transmitting the write request from the front end device to the read/write base unit.

In general, the aforementioned read/write base unit can communicate to whatever front end device the customer is using, such as, for example, a mobile computing device such as a smartphone, a tablet computing device, a laptop computer, and so on. Data is communicated to the front end device through a secure communication link such as a secure wireless communications network, Bluetooth communications, a wired data communications connection, and so on. The front end unit can be used to process the data sent to it, for example, formatting and display of the data, to calculate and update data values, and so on. If an update of the printed memory is required, then the front end device can send a write request to the read/write base unit and the read/write base unit will then write the update to the printed memory section of the ticket (e.g., the memory label).

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram illustrating a system for delivery tracking and recording, in accordance with an example embodiment;

FIG. 2 illustrates a workflow of operations which can be implemented in accordance with an example embodiment;

FIG. 3 illustrates a high-level flow chart of operations depicting logical operational steps of a method for delivery tracking and recording, in accordance with an example embodiment;

FIG. 4 illustrates a schematic view of a computer system, in accordance with an embodiment; and

FIG. 5 illustrates a schematic view of a software system including a module, an operating system, and a user interface. In accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

Unless defined otherwise, all technical and scientific terms used herein have the same meanings as commonly understood by one of ordinary skill in the art. As used in this document, the term “comprising” means “including, but not limited to.”

A “computing device” or “electronic device” or “data processing system” refers to a device or system that includes a processor and non-transitory, computer-readable memory. The memory may contain programming instructions that, when executed by the processor, cause the computing device to perform one or more operations according to the programming instructions. As used in this description, a “computing device” or “electronic device” may be a single device or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players, and the like. Various elements of an example of a computing device or processor are described below in reference to FIG. 5.

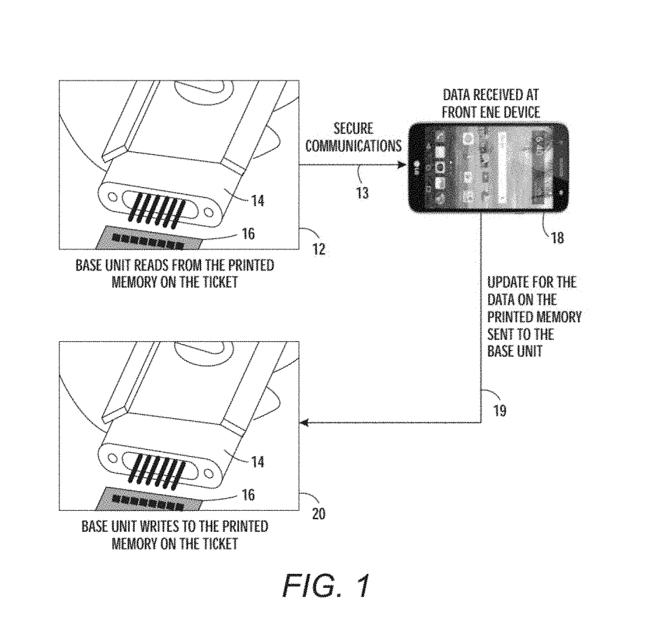

FIG. 1 illustrates a schematic diagram illustrating a system for delivery tracking and recording, in accordance with an example embodiment. In general, a printed memory 16 can be configured on a flexible substrate such as a ticket. A read/write base unit 14 can read from the printed memory 16 as indicated at block 12. The read/write base unit can communicate with a front-end device 18 over a secure communications link as indicated by arrow 13. Such a secure communications link can be, for example, a secure communications link over a wireless communications network (e.g., WiFi, cellular communications, Bluetooth communications, and so on) or a secure communications link over a wired data connection.

Note that the front-end device 18 is an example of a computing device, which can be adapted for use in accordance with one or more example embodiments. The computing device 18 can be, for example, a mobile computing device, such as, for example, a smartphone, table computing device, laptop computing device, and so on. In some example embodiments, the front-end device 18 may function as a client device in the context of, for example, a client-server data communications network. Such a client device can be, for example, a desktop computer or a portable device, such as a smartphone, an RF (Radio Frequency) device, an infrared (IR) device, a FDA (Personal Digital Assistant), a handheld computer, a tablet computer, a laptop computer, a desktop computer, a set top box, a wearable computing device, or an integrated device combining various features, such as various features of the aforementioned devices, or the like.

Data can thus be received at the front-end device from the printed memory 16 via the base unit 14 over such a secure communications link. As indicated at arrow 19, an update to the data contained on the printed memory 16 can be sent to the read-write base unit 14 from the front-end device 18. The read-write base unit 14 can thus write to the printed memory 16 contained on the flexible substrate, as shown at block 20. It should be appreciated that the data communications as indicated by arrow 19 can also occur over the aforementioned secure communications link.

The printed memory 16 (also referred to as a memory label) can contain data such as, for example, lot codes, serial numbers, expiration dates, delivery and address information, geographic codes, and so on. In some example embodiments, enhanced cryptographic security features can be provided and stored on the memory label/printed memory and can optionally be combined with optically readable codes (e.g., QR or barcodes). Note that the disclosed approach can also function as a relatively inexpensive back-up system for existing barcode systems used by most shipping/courier companies.

Thus, the front end device 18 can be used to process data sent to it from the base unit 14. The front end device 18 can process and then display such data via a display screen associated with the front end device 18 and/or can also calculate and update data values associated with the received data. If an update to the printed memory 16 is required, then the front end device 18 will send a write request to the base unit 14 and the base unit 14 will write the update to the printed memory section of the flexible substrate (e.g., a ticket).

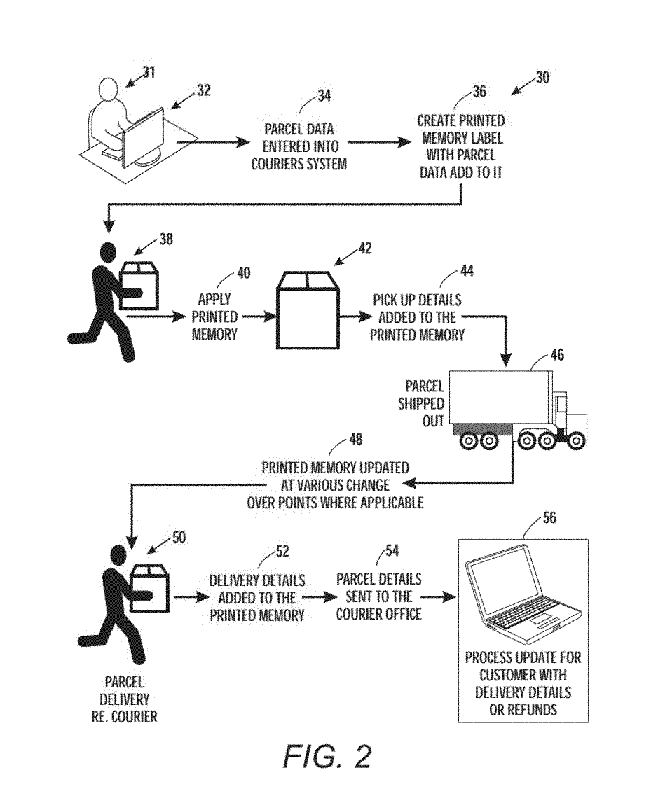

The printed memory 16 (e.g., memory label) generally includes micro-circuits printed on the printed memory 16 or memory label. Such micro-circuits include rewritable memory. The memory label is configured to include a pre-determined set of data regarding a package to be delivered in a delivery workflow (e.g., such as, but not limited to, the example delivery workflow 30 shown in FIG. 2) of a distribution network (e.g., a delivery network). The pre-determined set of data is stored in the rewritable memory. The pre-determined set of data can be updated at each subsequent point in the delivery workflow of the distribution network to produce updated data about the package.

Note that a non-limiting example of a read/write unit that can be utilized to implement the read/write base unit 14 shown in FIG. 1 is disclosed in U.S. Pat. No. 8,184,467, entitled “Card-Like Memory Unit With Separate Read/Write Unit,” which issued on May 22, 2012 and is incorporated herein by reference in its entirety. A non-limiting example of micro-circuits, which can be utilized to implement the aforementioned micro-circuits and printed memory/memory label, are disclosed in U.S. Pat. No. 9,412,705, entitled “Short circuit reduction in a ferroelectric memory cell comprising a stack of layers arranged on a flexible substrate,” which issued on August 9, 2016 and is also incorporated herein by reference in its entirety. A non-limiting example of a printed memory, which can be utilized to implement the printed memory or memory label discussed herein, is disclosed in U.S. Pat. No. 8,796,774, entitled “Printed Non-Volatile Memory,” which issued on Aug. 5, 2014 and is incorporated herein by reference in its entirety.

It should be appreciated that secure data communications represented by arrow 13 in FIG. 1 can include or can be facilitated by a data communications network that couple devices so that communications may be exchanged, such as between a server and a client device or other types of devices, including between wireless devices coupled via a wired or wireless network, for example. Such a network may include mass storage, such as network-attached storage (NAS), a storage area network (SAN), or other forms of computer or machine-readable media, for example. Such a network may also include the Internet, one or more Local Area Networks (LANs), one or more Wide Area Networks (WANs), wire-line type connections, wireless type connections, or any combination thereof. Likewise, sub-networks may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

In some example embodiments, the secure communications link (or channel) indicated by arrow 13 may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example, or via wireless communications as discussed herein.

Thus, in some example embodiment, the secure data communications link indicated by arrow 13 in FIG. 1 can be or can be facilitated by a wireless network that couples client devices with the wireless network. That is, such a wireless network may employ stand-alone ad-hoc networks, mesh networks, wireless LAN (WLAN) networks, cellular networks, or the like. Such a wireless network can further include a system of terminals, gateways, routers, or the like coupled by wireless radio links, or the like, which may move freely, randomly, or organize themselves arbitrarily, such that network topology may change, at times even rapidly. Such a wireless network may further employ a plurality of network access technologies, including Long Term Evolution (LTE), WLAN, Wireless Router (WR) mesh, or 2nd, 3rd, 4^{th}, 5th generation (2G, 3G, 4G, 5G, etc.) cellular technology, or the like. Network access technologies may enable wide area coverage for devices, such as client devices with varying degrees of mobility, for example.

For example, a wireless network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), mobile 5G, Bluetooth, 802.11b/g/n, or the like. Such a wireless network may include virtually any type of wireless communication mechanism by which signals may be communicated between devices, such as a client device or a computing device, between or within a network, or the like.

Signal packets communicated via such a network of participating digital communication networks may be compatible with or compliant with one or more protocols. The signaling formats or protocols employed may include, for example, TCP/IP, UDP, DECnet, NetBEUI, IPX, AppleTalk, or the like. Versions of the Internet Protocol (IP) may include IPv4 or IPv6.

The Internet refers to a decentralized global network of networks. The Internet includes Local Area Networks (LANs), Wide Area Networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc., that may route the signal packet in accordance with a target address and availability of a network path to the target address. Thus, in some example embodiments, secure data communications indicated by arrow 13 in FIG. 1 may be facilitated by the Internet.

FIG. 2 illustrates a workflow 30 of operations, which can be implemented in accordance with an example embodiment. As indicated by the workflow 30 shown in FIG. 2, a sender 31 (e.g., a customer) can log into a courier website via a computing device 32 and as shown at block 34, can enter sender/receiver address details and a shipping method (e.g., air/sea/first class/second class, etc.) into the courier system associated with or provided by the courier website.

Such details above and the calculated cost can be printed onto a flexible substrate such as a label or ticket as indicated at block 36. This label also contains a printed memory (e.g., printed memory electronics) to which all the printed information is stored. This printed memory can be referred to as a memory label as discussed herein.

Note that the user or sender 31 can change the shipping method or class of transit (e.g., air to sea, first class to second class, etc.) after the label is initially printed, and can also make other changes such as a change in the delivery utilizing the aforementioned courier website. It can be appreciated, of course, that the courier service associated with the website may impose, for example, a limited timeline by which the user/sender 31 can make such modifications, but by having this change ability, it provides the user/sender a more customized service.

The parcel can then be collected by a courier 38 (e.g., a postal employee, a UPS (United Parcel Service) employee, a FedEx employee, etc.) associated with the courier service and the printed memory applied to package 42, as indicated at block 40. In addition, data such as pick-up details and/or other information can be added to the printed memory, as shown at block 44.

The parcel is then shipped out via, for example, a truck 46 or other shipping method (e.g., by airplane, train, etc.). As shown at block 48, the printed memory can then be updated at various change-over points (where applicable) in the workflow 30. A courier 50 can then deliver the parcel/package and delivery details can be added to the printed memory, as shown at block 52. Parcel details can then be sent to the courier service's office as indicated at block 54. Thereafter, as shown at block 56, updates for the customer can be processed including information such as, for example, delivery details, refunds, etc.

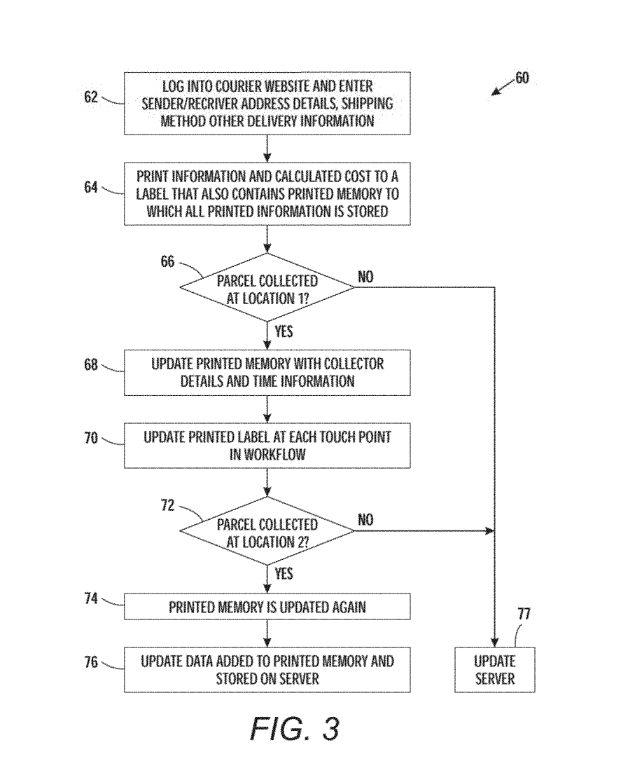

FIG. 3 illustrates a high-level flow chart of operations depicting logical operational steps of a method 60 for delivery tracking and recording, in accordance with an example embodiment. As indicated at block 62, a sender can log into a courier website and enter data such as sender/receiver address details, a shipping method (e.g., air/sea/first class/second class) and/or other delivery information. The sender/user can also enter payment (e.g. with a credit card, PayPal, etc.) through the courier website. The details above and the calculated cost can be printed onto a label as depicted at block 64. This label also contains printed memory to which all the printed information is stored.

As indicated next at decision block 66, a test can be performed to determine if the parcel has been collected at a first location. If the parcel is collected from the first location, then as indicated at block 68, a test or operation can be performed to update the printed memory with collector details and time information. If it is determined that the parcel was not collected at the first location, then as indicated at block 77, data concerning the lack of parcel collection at the first location can be added to a remote server, and this information may be utilized by the courier service/company for use in determining, for example, a refund to the customer/sender or for alerting courier staff/employees that a parcel was not collected at The first location. This updated information stored on the server may be used to determine that the package may, be have been lost or misplaced.

As indicated at block 70, at each touch point in the delivery workflow, the printed label can be updated. For example, as shown at decision block 72, a test can be performed to determine if the parcel was collected at a second location. If not, then the remote server discussed above can be updated with the appropriate information. If it is determined that the parcel was collected at the second location, then the printed memory can be updated again, as shown at block 74. This updated data can be added to the printed memory and centrally stored on the same server 76 discussed above (or another remote server), which the sender and/or the intended recipient of the package can access via the aforementioned courier website to determine the progress of the package delivery. If delivery targets have not been met, for example, a refund can be automatically made to an account associated with the sender/customer.

As can be appreciated by one skilled in the art, embodiments can be implemented in the context of a method, data processing system, or computer program product. Accordingly, embodiments may take the form of an entire hardware embodiment, an entire software embodiment, or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the users computer, partly on the user's computer, as a stand-alone software package, partly on the user's computer and partly on a remote computer, or entirely, on the remote computer. In the latter scenario, the remote computer may be connected to a user's computer through a local area network (LAN) or a wide area network (WAN), wireless data network e.g., W-Fi, Wimax, 802.xx, and cellular network, or the connection may be made to an external computer via most third party supported networks (for example, through the Internet utilizing an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example, a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or, other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

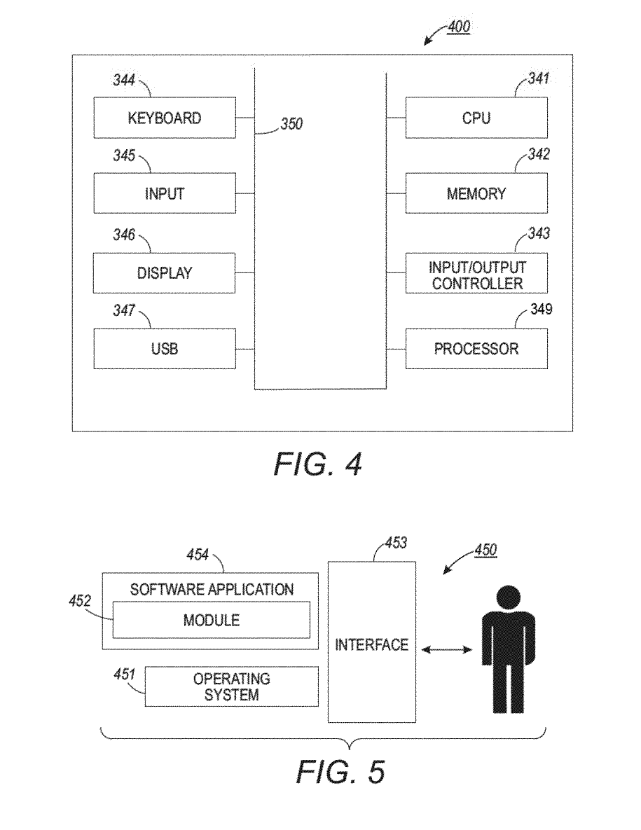

FIGS. 4-5 are shown only as exemplary diagrams of data-processing environments in which example embodiments may be implemented. It should be appreciated that FIGS. 4-5 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 4, some embodiments may be implemented in the context of a data-processing system 400 that can include, for example, one or more processors such as a CPU (Central Processing Unit) 341 and/or other another processor 349 (e.g., microprocessor, microcontroller etc), a memory 342, an input/output controller 343, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.), and/or other peripheral connections and components. FIG. 4 is an example of a computing device that can be adapted for use in accordance with an example embodiment.

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a Smartphone, a pad computing device, and so on, wherein each such device is operably connected to and/or in communication with a client-server based network or other types of networks (e.g., cellular networks, etc.).

FIG. 5 illustrates a computer software system 450 for directing the operation of the data-processing system 400 depicted in FIG. 4. Software application 454 stored, for example, in memory 342 or another memory (e.g., such as a memory of the mobile device front end device 18 shown in FIG. 1), can generally include one or more modules such as module 452. The computer software system 450 also can include a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453: these inputs may then be acted upon by the data-processing system 400 in accordance with instructions from operating system 451 and/or software application 454. The interface 453 in some embodiments can serve to display results, whereupon a user may supply additional inputs or terminate a session. The software application 454 can include module(s) 452, which can, for example, implement instructions or operations such as those discussed herein. Module 452 may also be composed of a group of modules.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that. module) and which includes source code that actually implements the routines in the module. The term module may also simply refer to an application, such as a computer program designed to assist in the performance of a specific task, such as word processing, accounting, inventory management, etc. Module 452 is an example of such a module and may include instructions (e.g., steps or operations) for performing operations such as those discussed herein with respect to FIGS. 1-3.

Based on the foregoing, it can be appreciated that a number of example embodiments, preferred and alternative, are disclosed herein. For example, in one embodiment a method can be implemented for tracking and recording package delivery data. Such a method can include steps or operations such as, for example, providing a memory label comprising micro-circuits printed on the memory label, the micro-circuits comprising rewritable memory; configuring the memory label to include a pre-determined set of data regarding a package to be delivered in a delivery workflow, the pre-determined set of data stored in the rewritable memory; and updating the pre-determined set of data at each subsequent point in the delivery workflow to produce updated data about the package.

In some example embodiments, the aforementioned memory label can include a reusable label that is reusable for future packages. The memory label can further include printed information about the package. In addition, a step or operation can be provide for attaching the memory label to the package at an initial point in the delivery workflow. In some example embodiments, the memory label can include both the printed information and the pre-determined set of data.

In yet another example embodiment, one or more steps or operations can be implemented for monitoring the package at each point in the delivery workflow utilizing the updated data about the package. In still other example embodiments, a step or operation can be provided for communicating data contained in the printed memory to a front end device with a read/write base unit wherein the data comprises the pre-determined set of data and/or the updated data, wherein the data is communicated to the front end device from the read/write base unit through a secure communications link comprising wireless data communications or a wired data communications link.

In another example embodiment, a step or operation can be provided for writing data to the printed memory from a read/write base unit, wherein the data comprises the pre-determined set of data and/or the updated data. In another example embodiment, steps or operations can be provided for transmitting a write request from a front end device to a read/write base unit, in response to a request to update date printed memory; and writing the updated data to the printed memory from the read/write base unit, in response to the transmitting the write request from the front end device to the read/write base unit.

In yet another example embodiment, a system for tracking and recording package delivery data can be implemented. Such a system can include, for example, one or more processors; and a non-transitory computer-usable medium embodying computer program code, the computer-usable medium capable of communicating with the processor (or processors). The computer program code can include instructions executable by the processor (or processors) and configured for: providing a memory label comprising micro-circuits printed on the memory label, the micro-circuits comprising rewritable memory; configuring the memory label to include a pre-determined set of data regarding a package to be delivered in a delivery workflow, the pre-determined set of data stored in the rewritable memory; and updating the pre-determined set of data at each subsequent point in the delivery workflow to produce updated data about the package.

In still another example embodiment, an apparatus for tracking and recording package delivery data can be implemented. Such an apparatus can include a memory label comprising micro-circuits printed on the memory label and rewritable memory, wherein the micro-circuits comprise the rewritable memory. The memory label includes a pre-determined set of data regarding a package to be delivered in a delivery workflow, the pre-determined set of data stored in the rewritable memory, and wherein the pre-determined set of data is updated at each subsequent point in the delivery workflow to produce updated data about the package.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for tracking and recording package delivery data, said method comprising:
providing a memory label comprising micro-circuits printed on said memory label, said micro-circuits comprising rewritable memory;
configuring said memory label to include a pre-determined set of data regarding a package to be delivered in a delivery workflow, said pre-determined set of data stored in said rewritable memory; and
updating said pre-determined set of data at each subsequent point in said delivery workflow to produce updated data about said package.

2. The method of claim 1 wherein said memory label comprises a reusable label that is reusable for future packages.

3. The method of claim 1 wherein said memory label further includes printed information about said package.

4. The method of claim 1 further comprising attaching said memory label to said package at an initial point in said delivery workflow.

5. The method of claim 4 wherein said memory label comprises both said printed information and said pre-determined set of data.

6. The method of claim 1 further comprising monitoring said package at each point in said delivery workflow utilizing said updated data about said package.

7. The method of claim 1 further comprising communicating data contained in said printed memory to a front end device with a read/write base unit wherein said data comprises said pre-determined set of data and/or said updated data, wherein said data is communicated to said front end device from said read/write base unit through a secure communications link comprising wireless data communications or a wired data communications link.

8. The>method of claim 1 further comprising further comprising writing data to said printed memory from a read/write base unit, wherein said data comprises said pre-determined set of data and/or said updated data.

9. The method of claim 1 further comprising:
transmitting a write request from a front end device to a read/write base unit in response to a request to update date printed memory; and
writing said updated data to said printed memory from said read/write base unit in response to said transmitting said write request from said front end device to said read/write base unit.

10. A system for tracking and recording package delivery data, said system comprising:
at least one processor; and
a non-transitory computer-usable medium embodying computer program code, said computer-usable medium capable of communicating with said at least one processor, said computer program code comprising instructions executable by said at least one processor and configured for:
providing a memory label comprising micro-circuits printed on said memory label, said micro-circuits comprising rewritable memory;
configuring said memory label to include a pre-determined set of data regarding a package to be delivered in a delivery workflow, said pre-determined set of data stored in said rewritable memory; and
updating said pre-determined set of data at each subsequent point in said delivery workflow to produce updated data about said package.

11. The system of claim 10 wherein said memory label comprises a reusable label that is reusable for future packages.

12. The system of claim 10 wherein said memory label further includes printed information about said package.

13. The system of claim 10 wherein said instructions are further configured for attaching said memory label to said,package at an initial point in said delivery workflow

14. The system of claim 13 wherein said memory label comprises both said printed information and said pre-determined set of data.

15. The system of claim 10 wherein said instructions are further configured for monitoring said package at each point in said delivery workflow utilizing said updated data about said package.

16. The system of claim 10 wherein said instructions are further configured for communicating data contained in said printed memory to a front end device with a read/write base unit wherein said data comprises said pre-determined set of data and/or said updated data, wherein said data is communicated to said front end device from said read/write base unit through a secure communications link comprising wireless data communications or a wired data communications link.

17. The system of claim 10 wherein said instructions are further configured for writing data to said printed memory from a read/write base unit, wherein said data comprises said pre-determined set of data and/or said updated data.

18. The system of claim 10 wherein said instructions are further configured for:
transmitting a write request from a front end device to a read/write base unit in response to a request to update date printed memory; and
writing said updated data to said printed memory from said read/write base unit in response to said transmitting said write request from said front end device to said read/write base unit.

19. An apparatus for tracking and recording package delivery data, said apparatus comprising:
a memory label comprising micro-circuits printed on said memory label; and
rewritable memory, wherein said micro-circuits comprise said rewritable memory, wherein said memory label comprises a pre-determined set of data regarding a package to be delivered in a delivery workflow, said pre-determined set of data stored in said rewritable memory, and wherein said pre-determined set of data is updated at each subsequent point in said delivery workflow to produce updated data about said package.

20. The apparatus of claim 19 wherein said memory label comprises a reusable label that is reusable for future packages and wherein said memory label further includes printed information about said package.
